(19) United States
(12) Patent Application Publication
(10) Pub. No.: US 2013/0081001 A1
(43) Pub. Date: Mar. 28, 2013

(54) IMMEDIATE DELAY TRACKER TOOL

(71) Applicants: Cameron McColl, Woodinville, WA (US); Philip Price, Seattle, WA (US); Bertan Aygun, Issaquah, WA (US); Shibani Basava, Redmond, WA (US)

(72) Inventors: Cameron McColl, Woodinville, WA (US); Philip Price, Seattle, WA (US); Bertan Aygun, Issaquah, WA (US); Shibani Basava, Redmond, WA (US)

(73) Assignee: Microsoft Corporation, Redmond, WA (US)

(21) Appl. No.: 13/241,229

(22) Filed: Sep. 23, 2011

(51) Int. Cl. G06F 9/44

(52) U.S. Cl. 717/128

(57) ABSTRACT

An immediate delay tracker tool listens for the occurrence of user-specified events that exceed a delay threshold. In an embodiment, the events are associated with immediate user actions processed by a user interface (UI) thread where the response time of the immediate user action requires an instantaneous response. When the event exceeds the delay threshold, the control flow of all the processes and/or threads in the system is recorded, filtered and then analyzed for the source of the delay.

### BACKGROUND

A user interface enables a user to interact with a software application. The user interface device may be a graphical user interface that accepts a user's action or input through a keyboard, mouse, touch screen display, and the like. The graphical user interface may be constructed using objects such as windows, menus, icons, buttons, pointers, boxes, and the like. The user may use these objects to input data, execute commands, and interact in general with a software application.

The slow response time of a user's action affects the usefulness of a software application. The response time should be as fast as possible. Certain user actions may be critical and require an immediate response. The delay between a user's action and the application's response may give the user the perception that the software application is not reacting instantaneously. Accordingly, improving the response time of the user interface enhances the user's overall experience with the software application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A user interacts with an application, such as an integrated development environment (IDE), through a user interface that relies heavily on user input or actions which may require an immediate response. The user actions are typically processed by a user interface (UI) thread which manages the IDE's user interface. Delays in the response to a user action affect the user's experience with the application. An immediate delay tracker tool traces the processing of the UI thread for user actions having delays in returning a response that exceed an anticipated response time.

The immediate delay tracker tool obtains a user-defined settings file indicating the events of interest, a delay threshold for each event, and a trace length for each event. The immediate delay tracker tool listens for the occurrence of an event that exceeds the delay threshold and then records a system-wide trace of the control flow of all the processes and threads running in the system for the length of time defined by the trace length. The immediate delay tracker tool waits for the first occurrence of the event to exceed the delay threshold before recording the system-wide trace which may capture subsequent user actions experiencing the same delay. In this manner, the amount of data that is recorded is minimized. The recorded data may then be filtered and analyzed for the source of the delay.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for tracking immediate delays of user actions.

FIG. 2 is a flow diagram illustrating the tracking of keyboard inputs having a lapsed time that exceeds a delay threshold.

FIG. 3 is a flow diagram illustrating a first exemplary method for tracking immediate delays.

FIGS. 4A-4B are flow diagrams illustrating a second exemplary method for tracking immediate delays.

FIG. 5 is a block diagram illustrating an operating environment.

FIG. 6 is a block diagram illustrating an exemplary computing device.

FIG. 7 is a block diagram illustrating an exemplary server.

### DETAILED DESCRIPTION

Various embodiments are directed to a mechanism for tracking delays in responding to user inputs that require an immediate response. In one or more embodiments, the user input may be input to an integrated development environment that provides tools and services to enable a user to build, test, and/or execute software applications. A user interacts with the IDE through a user interface that relies heavily on user input and actions which may require an immediate response. The immediate delay tracker tool is a mechanism that tracks delays in the response time of such user actions so that the source of the delay may be identified and remedied.

In one or more embodiments, the immediate delay tracker tool may track delays in displaying characters typed from a keyboard or delays in opening menus onto a display. The immediate user actions may be a keyboard stroke or the click on a menu option that is entered by a user. There is an expectation that there should be an instantaneous response in processing these events.

Immediate user actions are typically processed by a UI thread which manages the IDE's user interface. User interface events are represented as messages that are stored in a message queue until processed by the UI thread. The UI thread may be implemented as a message pump or loop that retrieves messages from a message queue and processes them accordingly. A goal of the UI thread is to continually retrieve messages from the message queue which is otherwise known in the art as pumping messages. In this manner, the actions triggering the messages are responded to quickly thereby improving the response time of the user's action.

An immediate delay tracker tool obtains a settings file indicating the events of interest, a delay threshold, and a trace length. The events of interest may be user actions that the UI thread processes, such as keyboard strokes, mouse clicks, opening a menu, and so forth. The delay threshold is a time unit that represents the maximum tolerable delay by a user. The trace length is a time unit that represents the amount of time the application is traced after it has exceeded the delay threshold.

The response time of immediate user actions may be very quick and may take as little as 50 milliseconds. Due to the quick response time of an immediate user action, the immediate delay tracker tool has to work in a manner that does not significantly increase the response time of the immediate user action. As such, the immediate delay tracker tool waits for the occurrence of the event to exceed the threshold before recording a system-wide trace. The system-wide trace may contain the call stacks of the processes and/or threads running during the trace.

There are certain immediate user actions that are repeated in succession consecutively, such as keyboard strokes and actions associated with opening a menu. If there is a delay in the processing of keyboard stroke, it is highly likely that the same delay may be experienced in subsequent keyboard strokes that occur immediately thereafter. The immediate delay tracker tool waits for the first time that such a user action exceeds the delay threshold before recording the system-wide trace so that the immediate delay tracker tool does not impede the response time of immediate user actions that are unlikely to experience the same delay.

The application being monitored, such as the IDE, may have marker events inserted in the application that identify the starting point and ending point of the execution of an event. The marker events are used to trigger the measurement of a response time of the application in processing the event. As such, an event may be identified by two marker events, such as when the event starts and when the event ends. The marker event may be an API call to an event trace engine that is notified of the start or end of an event. In response, the event trace engine may provide ETL event notifications to the immediate tracker tool from which the immediate tracker tool may determine if a delay has occurred. When the event exceeds the delay threshold, then the immediate delay tracker instructs the event trace engine to record a system wide trace of all the processes and/or threads running for a predetermined amount of time. Attention now turns to a more detailed discussion of the embodiments.

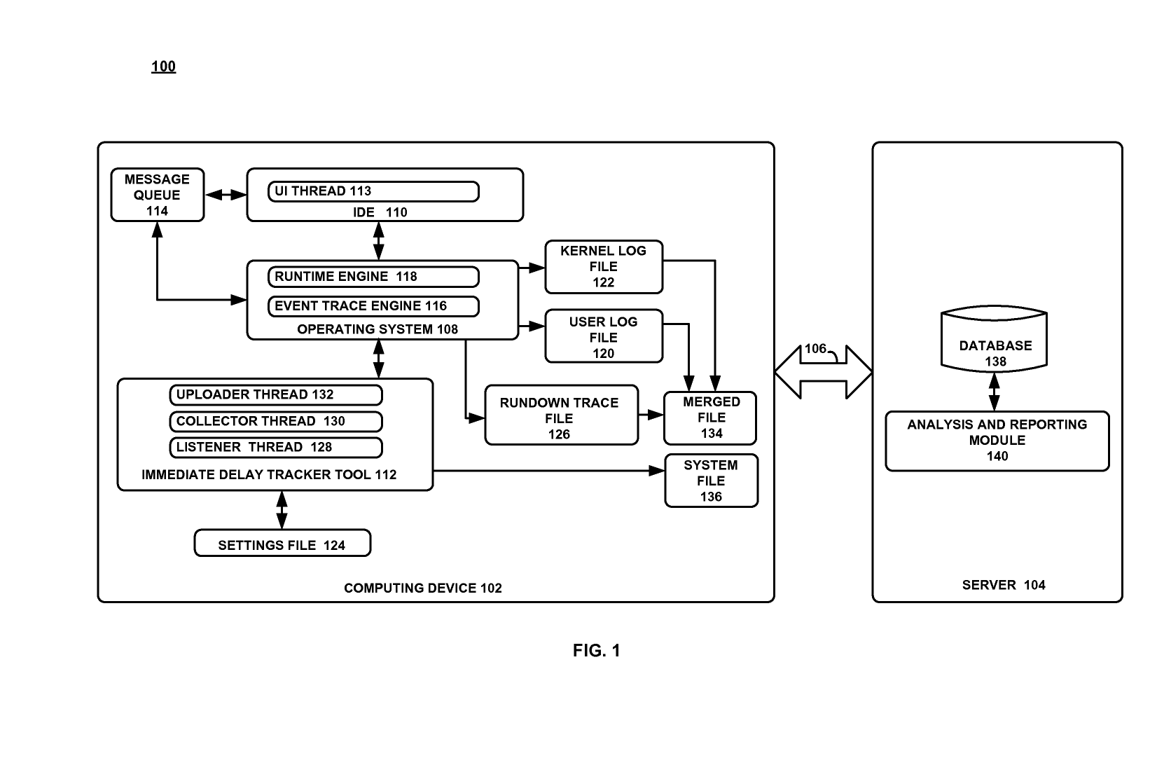

FIG. 1 illustrates a block diagram of an exemplary system for tracking delays in immediate user actions. The system 100 may include a computing device 102 and a server 104 communicatively coupled through a network 106. The computing device 102 and the server 104 may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof. The network 106 may be any type of communications link capable of facilitating communications between the computing device 102 and the server 104, utilizing any communications protocol and in any configuration, such as without limitation, a wired network, wireless network, or combination thereof. It will be appreciated that the network connections shown are exemplary and other means of establishing a communications link between the computing device 102 and the server 104 may be used as well.

In one or more embodiments, the computing device 102 may be utilized by a user of the IDE 110. The computing device 102 may include an operating system 108, an IDE 110, and an immediate delay tracker tool 112. The operating system 108, the IDE 110, and the immediate delay tracker tool 112 may be a sequence of computer program instructions, that when executed by a processor, causes the processor to perform methods and/or operations in accordance with a prescribed task. The operating system 108, the IDE 110, and the immediate delay tracker tool 112 may be implemented as program code, programs, procedures, module, code segments, program stacks, middleware, firmware, methods, routines, and so on. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The IDE 110 is a software application that provides tools and services that enable a user to build, test, and/or execute software applications. Microsoft's Visual Studio®, Delphi, JBuilder, FrontPage, and DreamWeaver are exemplary IDEs. The IDE 110 may contain multiple threads of execution, such as the UI thread 113. In an embodiment, the UI thread 113 may be implemented as a message pump. A message pump retrieves messages from a message queue 114 which are then forwarded to a corresponding event handler for processing. A sequence of messages may be translated or aggregated into an event. For example, the mouse button down message and the move message may be aggregated into a window resize event. Examples of other events may include keyboard input, time expiration, and so forth. The UI thread 113 calls the event handler associated with a message and waits for the completion of the execution of the event handler before retrieving another message.

Messages may be placed into the message queue 114 by the operating system 108. Retrieving a message from the message queue 114 may be referred to as pumping a message and the mechanism for retrieving messages from the message queue 114 and forwarding them for processing is otherwise known as the message pump. A goal of the UI thread 113 is to continually retrieve messages from the message queue 114 or to continually pump messages. In this manner, the events triggering the messages are responded to quickly thereby improving the performance and responsiveness of the UI thread 113. When the UI thread 113 takes an inordinate amount of time to process a message, the UI thread 113 is considered unresponsive. In order to improve the response time of the UI thread 113, it is important to know the source of the delay. In one or more embodiments, the immediate delay tracker tool 112 may be used to determine the slow response times of the UI thread in responding to user actions requiring immediate attention.

The operating system 108 manages and coordinates the resources and services needed to execute the IDE 110 and other programs. The operating system 108 may include an event trace engine 116 and a runtime engine 118. The event trace engine 116 may be a software application used to log kernel or application-defined events to a log file. The runtime engine 118 manages execution of managed code applications.

The event trace engine 116 logs or records data pertaining to events that may occur during execution of an application running under the operating system 108. An event may be any recordable activity that may occur in the operating system or application. In one or more embodiments, the event trace engine 116 may be tracing user interface events that occur within the UI thread 113 and/or the operating system 108.

In this context, an exemplary event may be the amount of time that the UI thread 113 is busy. This event may be specified as the time from when the UI thread 113 gets a message from the message queue to the time when the UI thread finishes processing the message. This event may be identified by a pair of marker events that are inserted into the UI thread 113 at the appropriate points where this delay may be measured.

The data that may be recorded includes the call stack of the thread, such as the UI thread 113, executing the event. A call stack is a data structure configured as a last-in-first-out stack of addresses of procedures that have been executed within a thread. By obtaining the call stack of a thread, a user of the IDE may be able to trace the control flow of the thread in order to determine the source of the delay.

The event trace engine 116 retrieves events from providers, such as the IDE 110 and/or the operating system 108. The IDE 110 and/or operating system 108 provide the event trace engine 116 with event content associated with the occurrence of an event. The event trace engine 116, in turn, provides the event content to a consumer of the event, such as the immediate delay tracker tool 112. The event content may be provided to the immediate delay tracker tool 112 in the form of an extract, transform, load (ETL) log file that may also include a timestamp, process and/or thread identifier, processor number, CPU usage data, and so on.

A consumer of the event trace engine 116, such as the immediate delay tracker tool 112, typically registers with the event trace engine 116 and specifies the events that the event trace engine 116 is to provide to the immediate delay tracker tool 112. In addition, the immediate delay tracker tool 112 may also instruct the event trace engine 116 to record specific events to one or more log files. For example, events related to an application, may be recorded to a user log file 120 and events related to the operating system kernel may be recorded to a kernel log file 122.

A settings file 124 may be used to specify the events to monitor as well as other information. For example, the settings file 124 may include the delay threshold and the trace length. The delay threshold is a time unit that represents the maximum tolerable delay by a user. The trace length is a time unit that represents the amount of time the event is traced after it has exceeded the delay threshold. In an embodiment, the settings file 124 may be an XML file having a set of tags that are used to specify the traceable events and related information. The settings file 124 may be generated by a user for use by the immediate delay tracker tool 112.

The runtime engine 118 manages applications written in managed code. Managed code is a file containing a binary assembly and metadata. The assembly is formatted in an intermediate language and the metadata identifies the classes, methods, and attributes associated with the assembly. Managed code executes within the runtime engine 118. As the managed code calls a method, the runtime engine 118 arranges for the method to be compiled into the corresponding machine code which is then executed. The runtime engine 118 may be considered a provider of events that occur within an application written in managed code. As such, the runtime engine 118 may provide these events to the event trace engine 116 which may then be recorded into a rundown trace file 126 or a user log file 120.

The immediate delay tracker tool 112 may be a software application that tracks the response times of events affecting the performance of an application in accordance with user-defined settings. The immediate delay tracker tool 112 may contain a listener thread 128, a collector thread 130, and an uploader thread 132. The listener thread 128 interacts with the event trace engine 116 to detect the occurrence of user-defined events that exceed the delay threshold. The collector thread 130 manages the collection of data relating to an event including processing the collected data into a format for use in a subsequent analysis. The uploader thread 132 manages the distribution of the collected data to other computing devices that may provide further analysis of the collected data.

The immediate delay tracker tool 112 may interface with the event trace engine 116 through APIs. Initially, the immediate delay tracker tool 112 registers with the event tracing engine 116 through a registration API. Thereafter, the immediate delay tracker tool 112 may interact with the event trace engine 116 at various points in the immediate delay tracker code by invoking a corresponding API. The immediate delay tracker tool 112 may request an ETL event notification for certain events by invoking a corresponding API, request that the event trace engine 116 record trace data through a corresponding API, and request that the event trace engine 116 merge all the collected data into a merged file 134.

The immediate delay tracker tool 112 may generate a system file 136 using the information from the merged file 134. The system file 136 may contain a list of the delays in the merged file that are of interest and additional information regarding the machine in which the traced data was generated. In one or more embodiments, the system file 136 may be configured in XML format.

There may be an enormous amount of data collected in a trace and the immediate delay tracker tool 112 identifies those delays that are of interest to a user in order to reduce the amount of data that is subject to analysis. The immediate delay tracker tool 112 may scan the merged file 134 and identify those events and delays in the merged file 134 that are of interest. The settings file 124 identifies the events and delays that are of interest to a user. The identified events and delays are then listed in the system file 136 in order to make the subsequent analysis of the data in the merged file 134 more efficient.

A server 104 may be utilized to analyze the traced data contained in the merged file 134 and the system file 136. The server 104 may include a database 138 and an analysis and reporting module 140. The database 138 stores the merged files 134 from one or more computing devices 102 and the analysis and reporting module 140 may be used to analyze the merged data and to formulate reports displaying an analysis. The analysis may be used to determine the conditions attributing to the delay of the events. In one or more embodiments, the database 138 may contain trace data from a single merged file 134 and in other embodiments, the database 138 may contain trace data from several merged files 134. By aggregating the merged files 134 across multiple users of an application, the source of a delay may be recognized more readily.

Although the system 100 shown in FIG. 1 has a limited number of elements in a certain configuration, it should be appreciated that the system 100 can include more or less elements in alternate configurations. For example, the server 104 may be arranged as a plurality of server machines or configured as a combination of server and client machines. There may also be several analysis and reporting modules 140 that may operate concurrently on one or more servers 104. Although the embodiments are described with reference to tracing user actions within an IDE, other applications than an IDE may be utilized and other events other than user interface events may be traced. The embodiments are not limited in this manner.

In various embodiments, the system 100 described herein may comprise a computer-implemented system having multiple elements, programs, procedures, modules. As used herein, these terms are intended to refer to a computer-related entity, comprising either hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. By way of illustration, both an application running on a server and the server may be an element. One or more elements may reside within a process and/or thread of execution, and an element may be localized on one computer and/or distributed between two or more computers as desired for a given implementation. The embodiments are not limited in this manner.

The various elements of system 100 may be communicatively coupled via various types of communications medium as indicated by various lines or arrows. The elements may coordinate operations between each other. The coordination may involve the uni-directional or bi-directional exchange of information. For instance, the elements may communicate information in the form of signals communicated over the communications medium. The information may be implemented as signals allocated to various signal lines. In such allocations, each message is a signal. Further embodiments, however, may alternatively employ data messages. Such data messages may be sent various connections. Exemplary connections include parallel interfaces, serial interfaces, and bus interfaces.

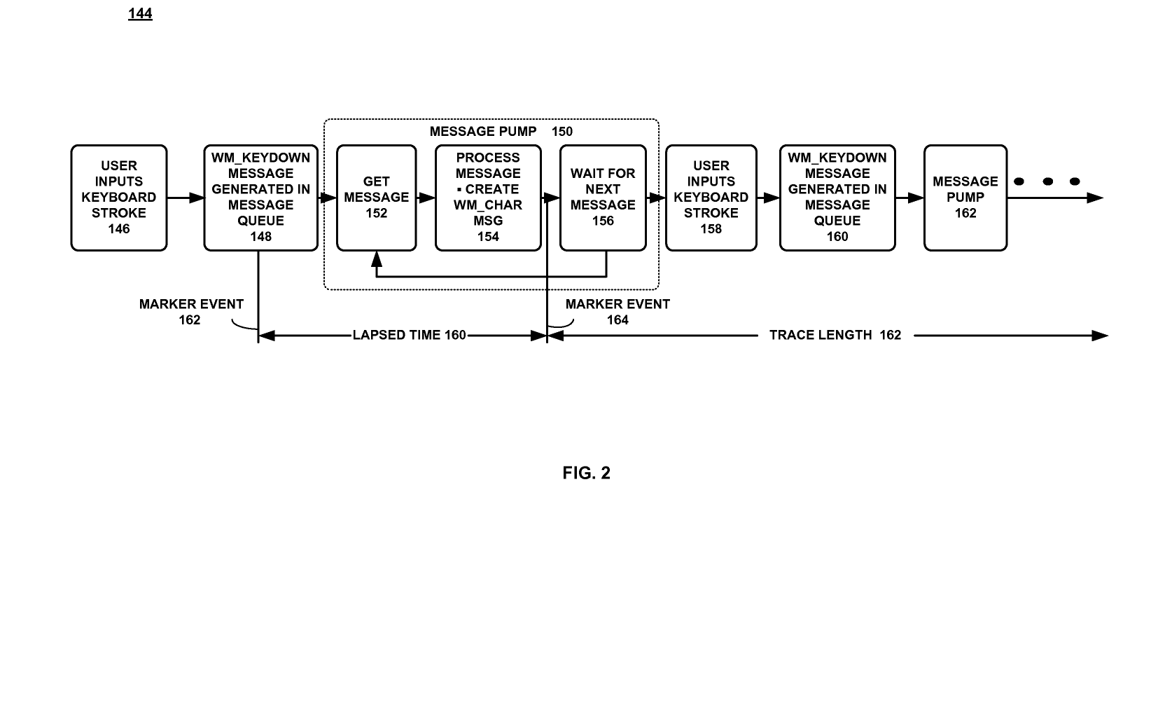

FIG. 2 illustrates the process of tracking an exemplary event. A user may enter a keyboard stroke (block 146) which is detected and processed into a WM_KEYDOWN message by the operating system (block 148). The WM_KEYDOWN message may include a timestamp indicating the time the keyboard stroke was detected and a keyboard scan code that uniquely identifies the keyboard stroke. The WM_KEYDOWN message may then be posted to the UI thread's message queue (block 148).

A message pump 150 processes the messages placed in the message queue. The message pump may be a loop that continuously retrieves messages off the message queue through a Get Message function 152, then initiates processing of the message through a Process Message function 154, and waits for the next message to be placed on the message queue through the Wait For Next Message function 156. The Process Message function 154 may retrieve the WM_KEYDOWN message which is then transformed into a WM_CHAR message that includes a time stamp indicating when the WM_CHAR message was posted, the keyboard scan code, and the character that was input through the keyboard stroke.

The response time of the keystroke input that is of interest may be the time from when the timestamp in the WM_KEYDOWN message is set to the time when the WM_CHAR message is finished processing, which occurs at the completion of the Process Message function 154. This response time is shown in FIG. 2 as lapsed time 160. Marker event 162 in the UI thread 113 may be used to identify the commencement point of the event and marker event 164 may be used to identify the end point of the event.

If the lapsed time 160 exceeds the delay threshold set for the keyboard stroke specified in the settings file 124, then the immediate delay tracker tool 112 initiates recording of all system wide events for a period of time defined by a trace length 162. All events occurring after the first delayed event are recorded even if there is no delay in a subsequent user action. In the case of immediate user actions, it is highly likely that a subsequent user action will experience a delay similar to the previous delay. However, by waiting for the occurrence of a delay to occur first, the amount of recorded data is reduced to a more manageable size. In addition, the recording time of the system-wide trace does not impede the response time of the immediate user action. Attention now turns to a more detailed description of various exemplary methods.

Operations for the embodiments may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

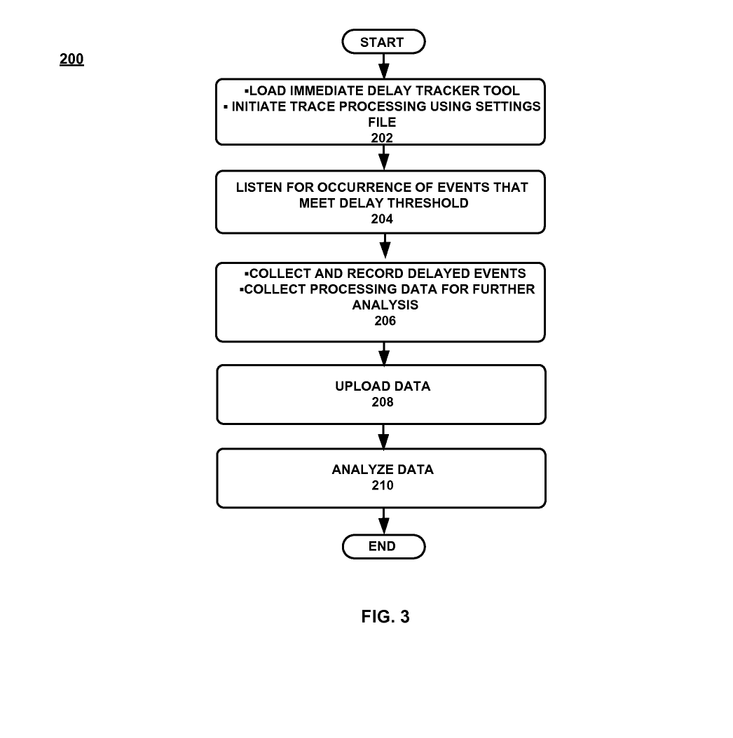

FIG. 3 illustrates a flow diagram of an exemplary method for tracking delays of immediate actions in the UI thread 113. The immediate delay tracker tool 112 may be loaded into the computing device 102 and initiated so that the trace may be processed as specified in the settings file 124 (block 202). In one or more embodiments, the immediate delay tracker tool 112 may be loaded as an extension to the IDE 110 in the form of an add-in, a component, a package, and the like. Upon activation of the IDE 110, the IDE 110 registers with the operating system 108 so that the IDE 110 executes in its own process that is separate from the process that the operating system 108 creates for the immediate delay tracker tool 112 (block 202). The immediate delay tracker tool 112 commences execution and reads in the data from the settings file 124 (block 202). The settings file 124 contains the events and delays specified by a user that the immediate delay tracker tool 112 may trace (block 202).

The immediate delay tracker tool 112 may create a listener thread 128 to listen for the occurrence of the events specified in the settings file 124 (block 204). The collector thread 130 may then be created to manage the recording of the traced events (block 206). The uploader thread 132 may be created to upload a merged file 134 of the traced events and a system file 136 to a server 104 (block 208). The files are then analyzed to determine the delays of each event (block 210). Attention now turns to a more detailed discussion of the method shown in FIG. 3.

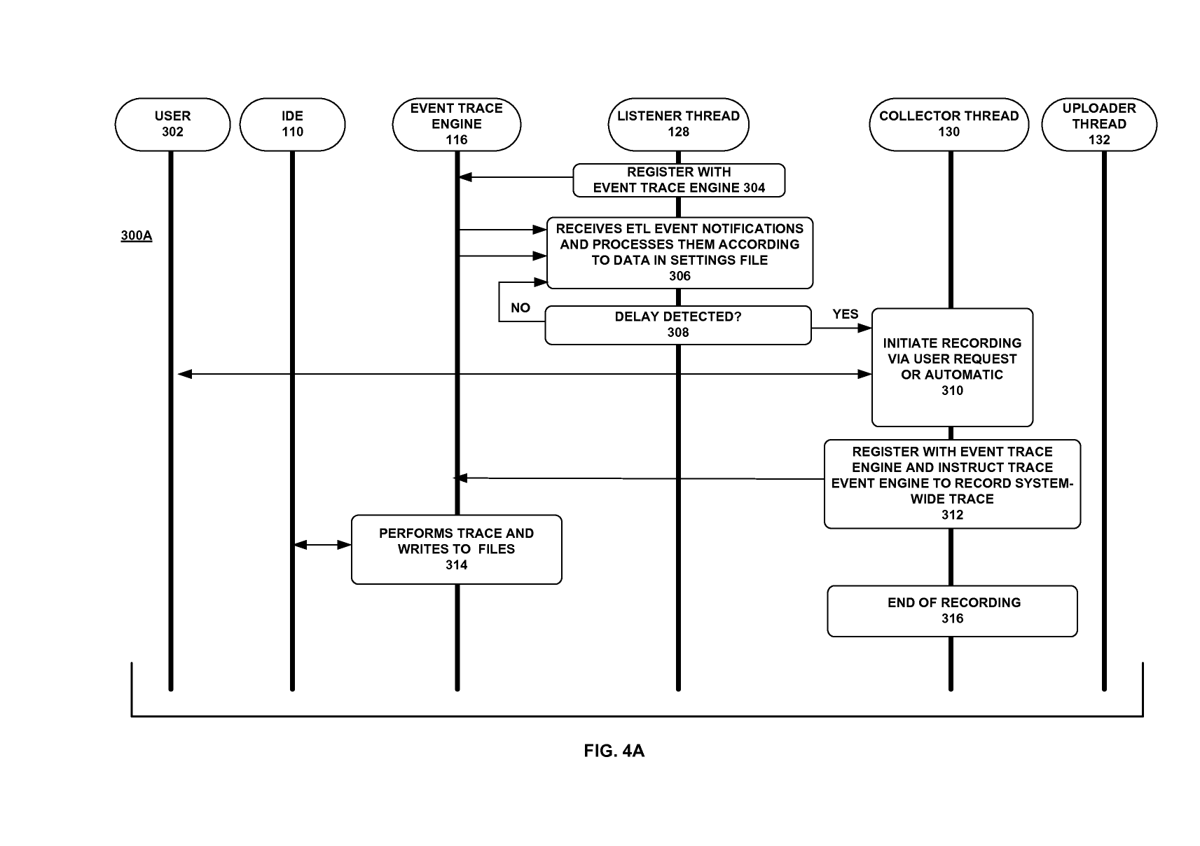

FIGS. 4A-4B illustrate a flow diagram of an exemplary method for tracking the delay of immediate actions in a UI thread. It should be noted that the method 300A, 300B may be representative of some or all of the operations executed by one or more embodiments described herein and that the method can include more or less operations than that which is described in FIGS. 4A-4B.

Referring to FIG. 4A, there is shown the IDE 110, the event trace engine 116, the listener thread 128, the collector thread 130, and the uploader thread 132 executing concurrently. In one or more embodiments, the IDE 110, the event trace engine 116, and the threads of the immediate delay tracker tool 128, 130, 132 may run in separate processes concurrently. A process is an instance of an application that is configured with the resources needed to execute it. A process may have its own memory space that is shared with the threads executing within the same process. The threads within the same process may communicate via messages or through a shared memory space. The IDE 110 runs in a process that may include the UI thread 113. The event trace engine 116 runs in a process that may include the operating system 108. The listener thread 128, collector thread 130, and the uploader thread 132 may run in the same process.

The listener thread 128 may register with the event trace engine 116 by invoking a register API in which the listener thread 128 indicates the events that the event trace engine 116 should trace (block 304). Each event may be associated with an event identifier that identifies the event. In addition, the listener thread 128 may specify the format of the traced data and other information as well (block 304). In one or more embodiments, the events may be user actions processed by the UI thread and identified through marker events contained in the UI thread. In this context, the event trace engine 116 forwards to the listener thread 128 those events specified in the registration API and in a format referred to herein as an extract, transform, and load (ETL) event notification. The ETL event notification may contain the event content and other information, such as a timestamp of when the event occurred, CPU usage, processor id, and so on.

The listener thread 128 analyzes the ETL event notification to determine if the execution time associated with the event is within the delay specified for the event from the settings file 124 (block 306). If the execution time is within the specified delay time for the event, then the ETL event notification may be discarded and the listener thread 128 waits for the next ETL event notification (block 308-no). If the execution time of an event exceeds the specified delay time for the event (block 308-yes), then listener thread 128 notifies the collector thread 130 to record a traceable event (block 310).

The collector thread 130 may request that the user 302 manually start collection or recording of the trace events (block 310). The user 302 may request the commencement of the recording (block 310). Alternatively, if the user 302 does not respond within a predetermined time or otherwise, the collector thread 130 proceeds to automatically instruct the event trace engine 116 to record a traceable event (block 310). In order to accomplish this task, the collector thread 130 registers with the event trace engine 116 using a register API that specifies the event to be recorded, such as a system-wide trace of the UI thread, and the length of time the recording may be made (block 312). The recording time may be specified in the settings file 124 (block 314).

Upon receipt of the collector thread's registration, the event trace engine 116 logs the events raised in the UI thread 113 in the user log file 120, the events raised in the kernel of the operating system 108 in the kernel log file 122, and the events raised by the runtime engine 118 in the rundown trace file 126 (block 314). The event trace engine 116 continues to write to each of these files during the duration of the recording time (block 314). Each of the log files may contain thousand of call stacks. For example, the user log file 120 may contain the call stacks associated with user processes and threads, the kernel log file 122 may contain the call stacks of operating system processes and threads, and the rundown trace file 126 may contain the call stacks of applications implemented in managed code. In some systems, a call stack may be generated every millisecond thereby generating in a four second trace length approximately four thousand call stacks. Next, the event trace engine 116 notifies the collector thread 130 of completion of the recordings (block 316).

Referring to FIG. 4B, the collector thread 130 then instructs the event trace engine 116 to merge the user log file 120, the kernel log file 122, and the rundown trace file 126 into a merged file 134 (block 318). The collector thread 130 reads the events and information logged in the merged file 134 to generate a system file 136 listing the delays that are of interest. The event trace engine 116 also may add in the merged file additional data pertaining to the computing device 102. For example, the file signature of each of the log files may be written in the merged 136 for later use in identifying a symbol file. For applications that are traced executing native or machine code, the call stacks may contain symbol names that refer to addresses. In order to resolve the symbol names, the symbol file corresponding to the computing device executing the trace is needed. The symbol file may be stored in an on-line symbol server. For this reason, the event trace engine 116 writes in the merged file 134 the file signatures of the log files so that the correct symbol file may be obtained in subsequent processing. Other system data may also be provided in the system file 136 such as the version of the operating system, the version of the application, unique session identifier, and so on.

The collector thread 130 references the settings file 124 which specifies the delays of interest and finds the corresponding delays in the merged file 134. These delays are then listed in the system file 136 for use in subsequent analysis. In addition, the information pertaining to the computing device executing the trace is written into the system file 136, such as the file signature, version of the operating system, and so on. However, the collector thread 130 may not need to perform this task and in some embodiments, the task of listing the delays of interest in the system file 136 may be performed by the aggregation and reporting module 140 on the server 104.

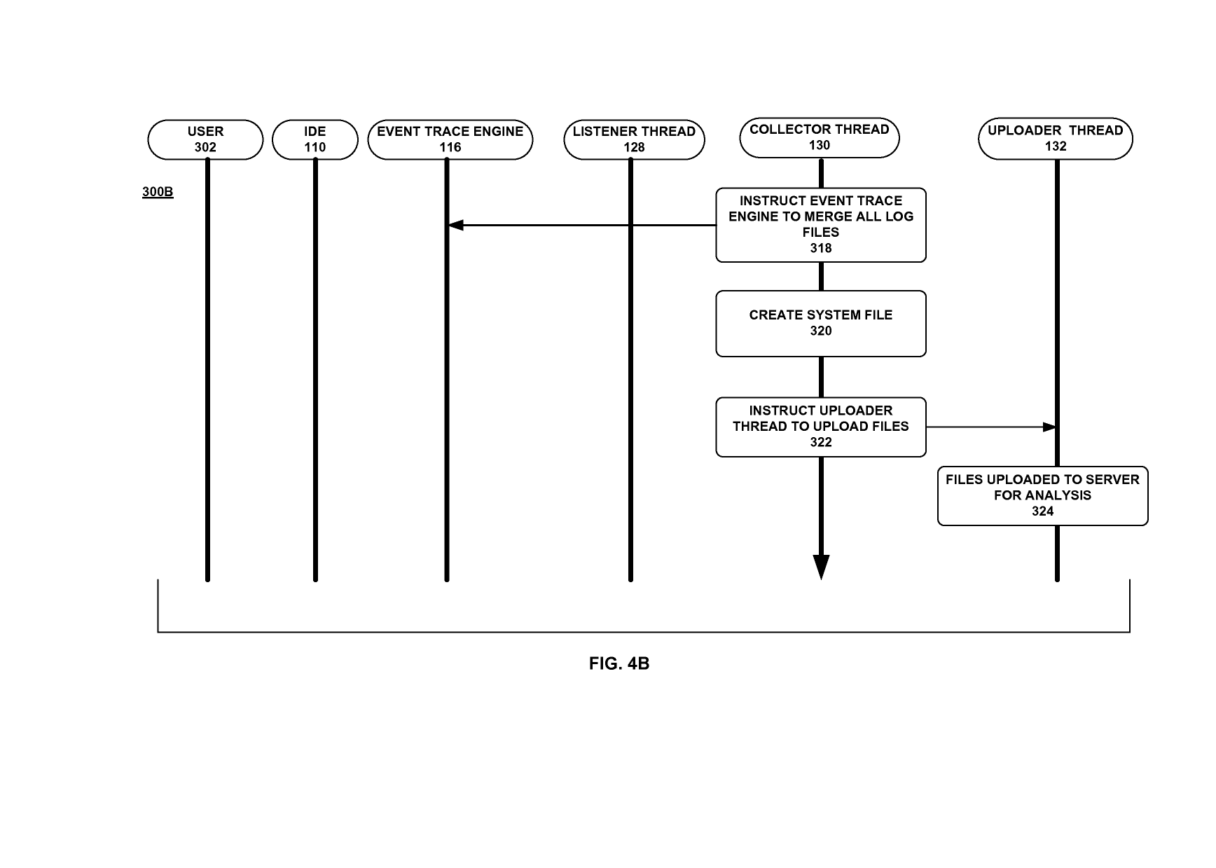

Attention now turns to a discussion of an exemplary operating environment for the embodiments described herein. Referring now to FIG. 5, there is shown a schematic block diagram of an exemplary operating environment 400. The operating environment 400 may include one or more client(s) 402 in communication through a communications framework 404 with one or more server(s) 406. The client(s) 402 may implement the client systems, such as the computing device 102 and the server(s) 406 may implement the server(s) 104.

A client 402 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A client 402 may also be embodied as a software module having instructions that execute in a single execution path, multiple concurrent execution paths (e.g., thread, process, etc.), or in any other manner

A server 406 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A server 406 may also be embodied as a software module having instructions that execute in a single execution path, multiple concurrent execution paths (e.g., thread, process, etc.), or in any other manner.

The communications framework 404 facilitates communications between the client 402 and the server 406. The communications framework 404 may embody any type of communications medium, such as wired or wireless networks, utilizing any communication protocol. Each client(s) 402 may be coupled to one or more client data store(s) 408 that store information local to the client 402. Each server(s) 406 may be coupled to one or more server data store(s) 410 that store information local to the server 406.

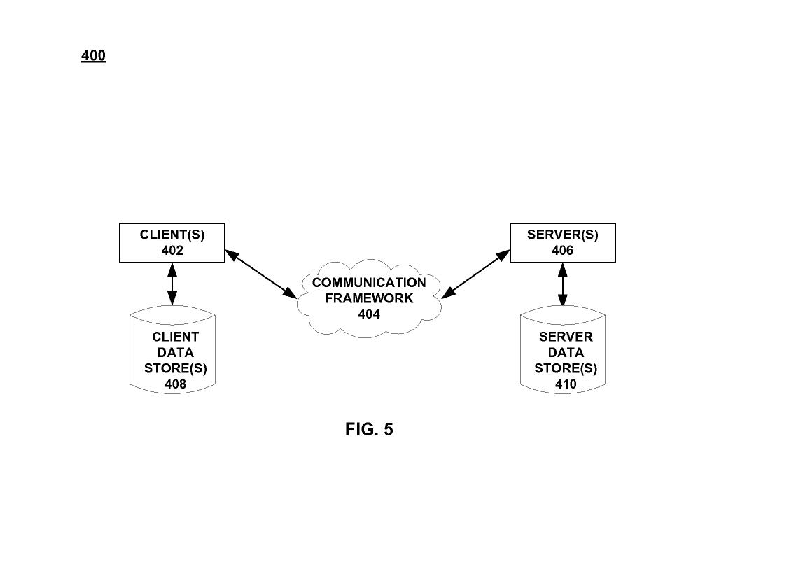

FIG. 6 illustrates a block diagram of an exemplary computing device 102. The computing device 102 may have a processor 502, a display 504, a network interface 506 for facilitating network communications, a user input interface 508 for accepting user input from input devices, and a memory 510. The memory 510 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 510 may also include one or more external storage devices or remotely located storage devices. The memory may 510 contain instructions and data as follows:
an operating system 108 having an event trace engine 116 and a runtime engine 118;
an IDE 110 having a UI thread 113;
an immediate delay tracker tool 112 having a listener thread 128, a collector thread 130, and an uploader thread 132;
a message queue 114;
a settings file 124;
a kernel log file 122;
a user log file 120;
a rundown trace file 126;
a merged file 134;
system file 136; and
various other applications and data 512.

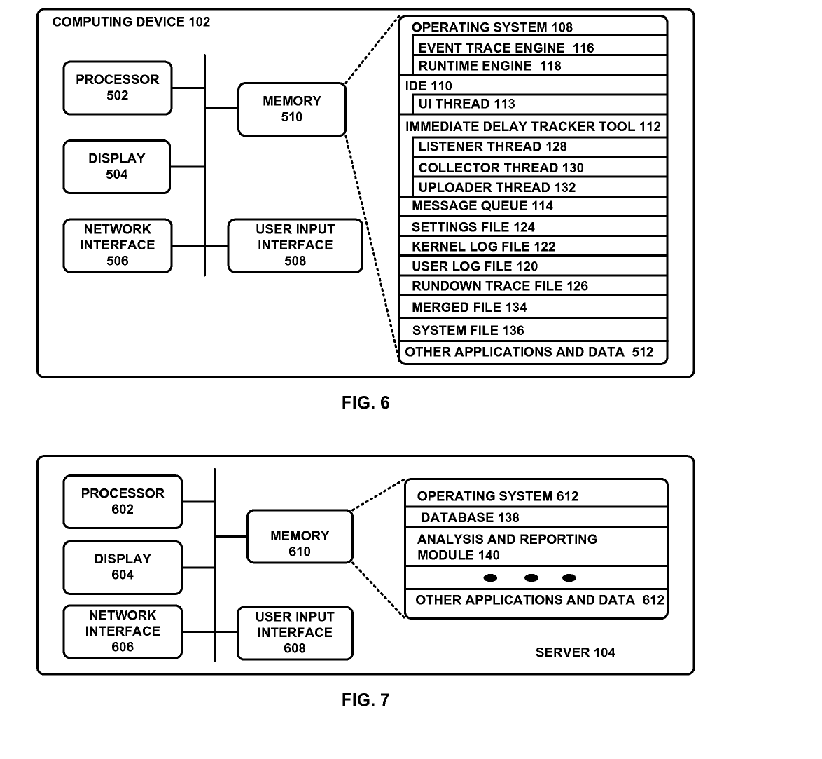

FIG. 7 illustrates a block diagram of an exemplary server 104. The server 104 may have a processor 602, a display 604, a network interface 606 for facilitating network communications, a user input interface 608 for accepting user input from input devices, and a memory 610. The memory 610 may be any computer-readable storage media that can store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 610 may also include one or more external storage devices or remotely located storage devices. The memory 610 may contain instructions and data such as one or more of the following:
an operating system 612;
a database 138;
an analysis and reporting module 140; and
other applications and data 612.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Although the technology has been described with respect to immediate user actions, such as keyboard strokes and menu clicks, the embodiments are not limited to immediate user actions and may be applied to any event that a user may want to trace within a system, such as without limitation, delays in scrolling, idle processing delays, and the like.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as programs, procedures, module, applications, code segments, program stacks, middleware, firmware, methods, routines, and so on. In an embodiment, for example, a computer-readable storage medium may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed:

1. A computer-implemented method, comprising:
identifying at least one event to occur during execution of an application, the event associated with a delay threshold and a trace length;
monitoring for occurrence of the event during execution of the application; and
recording a system-wide trace for the trace length, after determining that the event has exceeded the delay threshold.

2. The computer-implemented method of claim 1, the monitoring step further comprising:
providing one or more marker events in the application, each marker event to trigger a measurement of a response time of the application in processing the event.

3. The computer-implemented method of claim 2, further comprising:
determining a lapsed time from a first marker event to a second marker event, the lapsed time used to determine if the event exceeded the delay threshold.

4. The computer-implemented method of claim 1, wherein the event is associated with a response of the application to an immediate user action.

5. The computer-implemented method of claim 1, further comprising:
providing a user-defined settings file that identifies one or more events to be monitored, a delay threshold for each event, and a trace length for each event.

6. The computer-implemented method of claim 1, further comprising:
generating a user log file containing a plurality of call stacks provided by the application; and
generating a kernel log file containing a plurality of call stacks provided by an operating system.

7. The computer-implemented method claim 6, further comprising:
generating a rundown trace file containing a plurality of call stacks.

8. The computer-implemented method of claim 7, further comprising:
merging the user log file, kernel log file, and the rundown trace file into a merged file; and
identifying one or more delays from the merged file.

9. The computer-implemented method of claim 1, the recording step further comprising:
obtaining user intervention to initiate recording of the system-wide trace.

10. The computer-implemented method of claim 1, wherein the application is a UI thread.

11. A computer-readable storage medium storing thereon processor-executable instructions, comprising:
an application having instructions for execution on a processor, the application having a plurality of marker events, each marker event identifying a point in the application where processing of an immediate user action occurs;
a settings file having a plurality of events, a plurality of delay thresholds, and a plurality of trace lengths, each event associated with an immediate user action, each delay threshold associated with an event, and each trace length associated with an event; and
an immediate delay tracker tool having instructions that when executed on a processor obtains an event, delay threshold, and trace length from the settings file and monitors for occurrence of the event when raised by one or more marker events during execution of an application, the immediate delay tracker tool having further instructions that when executed on a processor records a system-wide trace of all processes executed after occurrence of the event when the event executes for a duration that exceeds the trace length.

12. The computer-readable storage medium of claim 11, wherein the application is an integrated development environment.

13. The computer-readable storage medium of claim 11, wherein the event is associated with an immediate user action.

14. The computer-readable storage medium of claim 11, further comprising:
an event trace engine having instructions that when executed on a processor provides the immediate delay tracker tool with a notification of an occurrence of the event; and
the immediate delay tracker tool having instructions that when executed on a processor uses the notifications to determine whether a delay has occurred.

15. The computer-readable storage medium of claim 11, further comprising:
a merged file containing log data obtained from a user log file, a kernel log file and a rundown file, the user log file containing data associated with execution of the application during the trace length, the kernel log file containing data associated with execution of an operating system during the trace length, and the rundown file containing data associated with execution of a managed code application during the trace length.

16. The computer-readable storage medium of claim 15, the immediate delay tracker tool having instructions that when executed on a processor analyzes the merge file to identify delays associated with the events identified in the settings file which are stored in a system file.

17. A computer-readable storage medium, storing thereon processor-executable instructions, comprising:
a UI thread having instructions that when executed on a processor processes a plurality of user actions, each user action associated with an event having a delay threshold;
an event trace engine having instructions that when executed on a processor provides one or more event notifications when the UI thread processes the event; and
an immediate delay tracker tool having instructions that when executed on a processor obtains a list of events to monitor, instructs an event trace engine to provide event notifications when the UI thread processes the event, determines when an event exceeds a delay threshold, and instructs the event trace engine to perform a system-wide trace when occurrence of the event exceeds the delay threshold.

18. The computer-readable storage medium of claim 17,
the UI thread having one or more marker events associated with an event, each marker event identifying a point in execution of the UI thread where the user action is processed.

19. The computer-readable storage medium of claim 17,
the event trace engine having further instructions that when executed on a processor, performs a system-wide trace by logging execution of all processes and threads into one or more log files.

20. The computer-readable storage medium of claim 19,
the immediate delay tracker tool having further instructions that when executed on a processor analyzes the log files to identify delays associated with the events.
